(19) United States
(12) Patent Application Publication
(10) Pub. No.: US 2013/0264994 A1
(43) Pub. Date: Oct. 10, 2013

(54) BATTERY MANAGEMENT SYSTEM FOR A POWER SUPPLY SYSTEM WITH A LOW-VOLTAGE REGION AND A HIGH-VOLTAGE REGION

(71) Applicant: Tim Schaefer, Hartzor (DE)

(72) Inventor: Tim Schaefer, Hartzor (DE)

(73) Assignee: LI-TEC BATTERY GMBH, Kamenz, DE (DE)

(21) Appl. No.: 13/880,665

(22) PCT Filed: Oct. 20, 2011
(86) PCT No.: PCT/EP2011/005292

§ 371 Date: Jun. 19, 2013

(30) Foreign Application Priority Data
Oct. 20, 2010 (DE) 10 2010 048 985.9

(51) Int. Cl. H02J 7/00

(52) U.S. Cl. CPC H02J 7/007
USPC 320/104; 320/135; 320/136

(57) ABSTRACT

A power supply system (1), in particular for an electric drive or hybrid drive of a motor vehicle, has the following components: an electrical energy storage device (2) which supplies a low voltage and which has at least one energy storage cell (3) and/or at least one cell module (4) composed of at least two energy storage cells (3), an electrical load (5) which is operated with a high voltage, a voltage transformer (6), in particular a DC voltage transformer, which transforms a low voltage into a high voltage and/or a high voltage into a low voltage, and a control device (8) for controlling the electrical energy storage device (2). In addition, the power supply system (1) has a low voltage region (9) in which the electrical energy storage device (2) is arranged, and a high-voltage region (10) in which the electrical load (5) is arranged. It is proposed that the control device (8) be arranged essentially in the low-voltage region (9) of the power supply system (1). In one particularly preferred embodiment of the invention, the control device (8) is integrated essentially in the voltage transformer (6).

The present invention relates to a power supply system, particularly for an electric or hybrid drive of a motor vehicle, having a low-voltage region and a high-voltage region, an electrical energy storage device supplying a low voltage and arranged in the low-voltage region of the power supply system, as well as an electrical load operated at a high voltage and arranged in the high-voltage region of the power supply system.

The invention is described with reference to use in a motor vehicle and the power supply system for the electric or hybrid drive of the motor vehicle. It is, however, pointed out that a power supply system according to the invention can also be used for other applications independent of motor vehicles, particularly stationary applications.

To be understood as a power supply system in the context of the present invention is a system having a power source for generating electrical energy, components for transmitting and, if needed, converting the electrical energy, an electrical load for converting the electrical energy into another form of energy such as mechanical or thermal energy as well as devices for controlling these processes and possibly further components as well. The power supply system comprises an electrical energy storage device which supplies a low voltage and an electrical load operated at a high voltage.

A low voltage in the sense of the present application refers to a voltage between 0 and 90 V, preferably between 30 and 60 V, and further preferably between 40 and 50 V. A high voltage in the sense of the present application refers to a voltage higher than 90 V, preferably higher than 150 V, and further preferably higher than 250 V.

It is pointed out that while these voltage range limits do not necessarily coincide with the customary voltage range limits for low and/or high voltages in the field of electrical energy engineering, they are, however, customary voltage ranges in the field of electrical automotive technology for electrical energy storage devices, particularly batteries such as lithium ion batteries or electrical loads such as electric motors for driving the vehicles, for example.

The low voltage supplied by the electrical energy storage device is preferably a direct current. The voltage at which the electrical load is operated is preferably an alternating current.

To be understood by an electrical energy storage device is a device for storing energy which is released in the form of electrical energy. The electrical energy storage device can thereby be an energy storage device which functions solely according to electrical principles, for example a capacitor, or an electrochemical energy storage device, for example a (non-rechargeable) primary battery or a (rechargeable) secondary battery, i.e. an accumulator.

The invention is described in reference to rechargeable electrical energy storage devices but can, however, also be applied to non-rechargeable electrical energy storage devices.

The electrical energy storage device comprises at least one, preferably a plurality of energy storage cells. An energy storage cell is to be understood as the smallest structural unit in which energy can be stored within an electrical energy storage device. For example, an energy storage cell comprises an electrode assembly of a plurality of anodes, cathodes and interstitial separators arranged in a cell housing, wherein the electrode assembly in an electrochemical energy storage device is impregnated with an e.g. liquid or gelular electrolyte, as well as a conductor for the discharge and/or charge current and further devices such as protective circuits or protective apparatus against overheating.

An electrical energy storage device can furthermore comprise at least one cell module. A cell module refers to a structural unit within the electrical energy storage device which comprises at least two energy storage cells having an electrical connection which does not disconnect during normal operation. Preferably, a cell module comprises a housing in which the at least two electrically connected energy storage cells are accommodated, a common outward-leading electrical connection, and preferably further apparatus such as control circuits, sensors and cooling and/or extinguishing devices. The cell modules within the electrical energy storage device are preferably connected to one another in parallel.

Although the energy storage cells within a cell module can be interconnected in any desired arrangement, it is however preferable for them to first be connected in series and then in parallel. For example, between 2 and 14 energy storage cells are first aligned in a series and serially connected into a strand of cells and four such cell strands then connected in parallel. For example, a series connection of twelve energy storage cells each having a nominal voltage of 4 V yields a nominal voltage for the cell strand—and thus also for the parallel connection of four cell strands—of 48 V, i.e. a low voltage in the sense as used here.

For safety reasons, this type of low voltage is extremely desirable for the operation of an electric vehicle since there is no direct danger of contacting live parts to passengers in the case of a malfunction or to rescue personnel summoned in the event of an accident.

On the other hand, it is desirable to operate the electric motor at a high voltage in the sense as used here in order to always ensure that the necessary and/or desired torque will be generated so as to achieve sufficient vehicle performance and a high level of driving comfort, e.g. in terms of acceleration capability, maximum speed or the vehicle's tractive power.

The power supply system therefore further comprises a voltage converter, particularly a DC/DC converter, which converts a low voltage into a high voltage and/or a high voltage into a low voltage. The voltage converter converts the low voltage produced by the electrical energy storage device into the high voltage needed by the electrical load.

A reverse power flow can also be provided in the power supply system, i.e. from the electrical load to the electrical energy storage device, preferably in order to realize regenerative braking, thus the feedback of brake energy by an electric motor operated as a generator when braking. In this case, the voltage converter also converts the high voltage supplied by the electrical load into the required low voltage with which the electrical energy storage device, if same is rechargeable, can then be charged.

Should the high voltage required by the electrical load be an alternating voltage, the power supply system further comprises an inverter which converts the high direct voltage supplied by the voltage converter into the high alternating voltage required by the electrical load.

Should the power supply system comprise an inverter, a further reason to make use of high voltage then results from the fact that correspondingly smaller currents than with a low voltage need to flow in order to achieve the necessary electrical power. Since the costs of power semiconductors in inverter electronics increase faster with the current than with the voltage for which it is designed, there is a cost advantage for the inverter when using a high voltage. For the same reason, the lines preferably made of copper within the power supply system can be designed with a smaller cross section when using a high voltage and are thus lighter and less expensive than when using a low voltage.

Lastly, without a voltage converter, it would be necessary for the generation of a high voltage by electrical energy storage device, to connect a large number of energy storage cells in series. However, this is inefficient since there is an overall loss of capacity in a series connection due to the generally slightly different capacities of the individual energy storage cells.

A power supply system of the type described above which comprises an electrical energy storage device, an electrical load and a voltage converter is known for example from the U.S. Pat. No. 5,373,195 patent application.

The power supply system further exhibits a low-voltage region and a high-voltage region.

The low-voltage region essentially contains all the components of the power supply system which are operated exclusively at low voltage. Hence, all the voltages prevailing in the low-voltage region are low voltages.

The high-voltage region essentially contains all the components of the power supply system which are operated entirely or partially at a high voltage. Thus, the voltages prevailing in the high-voltage region are substantially high voltages. However, lower voltages than the high voltages can also prevail in the high-voltage region since they—as opposed to the reverse case in the low-voltage region—pose no safety problem.

The voltage converter forms the interface between the low-voltage region and the high-voltage region here with those of its components which only conduct low voltages are contained within the low-voltage region with the rest of its components contained within the high-voltage region.

The power supply system furthermore comprises a control device for controlling the electrical energy storage device, preferably a battery management system. Control devices of this type perform a plurality of functions, preferably the monitoring and controlling of discharging and, if applicable, charging of the connected electrical energy storage devices based on measured parameters of the electrical energy storage devices such as voltages, currents and temperatures, as well as correctively intervening in the cited processes as needed to ensure safe and optimized vehicle operation. To this end, in addition to the electrical energy storage device, the control device is also connected to a plurality of other vehicle components within and external of the power supply system, for example to the electrical load, the voltage converter and further components such as e.g. an engine management system, an external charging device, an external diagnostic device or sensors mounted in a vehicle, e.g. acceleration sensors for impact detection.

Such control devices for electrical energy storage devices are known for example from the DE 10 2008 009 970 and DE 10 2008 052 986 patent applications filed by the applicant of the present patent application.

DE 10 2008 009 970 proposes a control apparatus particularly for a rechargeable energy storage unit (“battery management system”) which comprises at least one first control device and at least one first storage unit as well as a second control device and a second storage unit, wherein the first control device monitors compliance with a target value for at least one functional parameter of at least one galvanic cell, wherein the target value for the functional parameter is stored in the first storage unit. The first and the second storage units are thereby signal-connected and thus exchange data on the functional parameters of the galvanic cells as well as “signs of life” with one another. The present patent application also describes evaluating the functional parameters of the galvanic cells over time as well as the prognosis of their future performance over time, for example with the goal of determining the progressive aging of the energy storage unit.

The object of DE 10 2008 052 986 is technically advancing such a battery management system by way of an integrated circuit.

The object of the present patent application's invention consists of providing a power supply system of the described type which capitalizes on the power supply system's structure and enables the power supply system to be safely operated.

This object is accomplished by a power supply system having the features of independent claim 1. The dependent subclaims specify advantageous further developments of the invention.

In accordance with the invention, the control device is substantially arranged in the low-voltage region of the power supply system. Only individual components of the control device, such as control lines or sensors which establish the connection to components within the high-voltage region such as the electrical load may conceivably not be arranged within the low-voltage region. However, these are only components which are not absolutely imperative for the operation of the control device. The control device can also continue to perform a majority of their functions should some or all of these components be switched off.

The arrangement according to the invention of the control device substantially in the low-voltage region has the advantage of being able to provide a clear functional partitioning of the power supply system into the low-voltage region and the high-voltage region. In particular, the low-voltage region continues to remain functional when the high-voltage region is switched off, for example for safety reasons, or is unavailable for other reasons.

In a particularly preferred embodiment of the invention, the control device is substantially integrated into the voltage converter.

The term “integration” can hereby on the one hand mean that both apparatus are realized together as one single component which can be mounted into the vehicle in one power to the two apparatus, are also only provided once. The two apparatus are preferably accommodated within one common housing.

The term “integration” can however also have the further meaning that both apparatus are realized in the form of one single integrated circuit, which likewise comprises certain connection lines only once and/or is accommodated within just one housing.

Apart from the obvious advantages associated with one single component versus two separate components—including a smaller space requirement, lower weight, lower manufacturing and installation costs as well as lower energy consumption—the integration of the control device into the voltage converter yields a further synergistic effect in that specific electronic components such as microcontrollers or microprocessors, memory elements or power electronics components only need to be provided once.

In addition, if the control device is integrated into the voltage converter, the low voltage generated by the electrical energy storage device as well as the high voltage generated by the voltage converter both of which are available within the voltage converter, can be directly and thus very easily measured within the integrated components.

To realize the functions of the control device, for example as a battery management system, essentially only sensors for the parameters of the electrical energy storage device, e.g. cell voltages, currents or temperatures, are then needed as further components. Such sensors and possibly a—preferably “non-intelligent”—subset of the components of the power supply system needed for processing the sensors' measured values, e.g. signal amplifiers, analog/digital converters, encoding or modulation circuitry, are preferably disposed in or on the energy storage cells and/or the cell modules.

The just described arrangement of the control device enables a particularly simple structure for the power supply system.

In one preferred embodiment of the invention, the control device comprises a measuring device for measuring at least one functional parameter of at least one energy storage cell, an evaluating device for evaluating at least one functional parameter of the at least one energy storage cell and at least one storage unit for storing said functional parameter or a variable derived from said functional parameter.

To be understood by a measuring device is a device for measuring a functional parameter of an energy storage cell. This could for example be sensors for measuring electrical variables such as electrical voltage, electric current and electrical charge, but also for measuring the temperature of the energy storage cell.

Functional parameters refer to physical variables which can serve in specifying an energy storage cell. These are for example the electrical capacity of the energy storage cell, the electrical off-current voltage measurable between the two poles of the energy storage cell or the load-dependent terminal voltage, the intensity of an electric current for charging or discharging, the internal resistance of an energy storage cell, an energy storage cell's already charged or available electrical charge, leakage currents between the poles within an energy storage cell or the temperature of the cell. Other additional physical variables can also be of interest depending on the type of electrical energy storage device and the requirements set for its operation.

An evaluating device refers to a device for converting a functional parameter from a physical into a arithmetical variable, for example by scaling, for the purpose of mathematical processing, for example by relating same to other measured functional parameters or other variables using predefined calculation rules or for the purpose of other processing such as a summarizing or sorting of the detected variables. The evaluating device also serves in the utilizing of a measured functional parameter for further processing by the control device.

The storage unit serves in storing measured functional parameters or variables derived therefrom such as e.g. associated integrated or differentiated values. A time stamp is also stored along with these values in order to be able to later follow the processes in the energy storage cells over time. A storage unit is thereby, for example, an electronic, magnetic or optical recordable device for the volatile or non-volatile storage of data, for example a RAM, a Flash memory, an EEPROM, a hard disk or a recordable Compact Disc.

In a further preferred embodiment of the invention, the variable derived from the functional parameter is the aging and/or the residual lifespan of the electrical energy storage device, a cell module or an energy storage cell. This is important since the behavior of an energy storage cell can change with advancing age such that for example an unmodified charging process can lead to a reduced charge or a reduced available voltage of the energy storage cell.

To determine the aging of the energy storage cell, the evaluating device for instance projects the future trend over time for the functional parameters of the energy storage cell measured by the measuring device and thus also determines the future absorbable electrical charge of the energy storage cell and/or its extractable electrical charge and/or its highest attainable electrical voltage. Doing so allows a predication to be made about the further operation of the electrical energy storage device. From a projection on the aging of one or more energy storage cells, a projection on the economic remaining lifespan of these energy storage cells, individual cell modules or the electrical energy storage device as a whole can also be made. Doing so also allows for signaling necessary maintenance or replacement.

In a further preferred embodiment of the invention, upon a functional parameter of an energy storage cell deviating from a target value, the control device initiates at least one measure to ensure adherence to the target value and/or switches off the energy storage cell should the measure fail. Such measures preferably serve the safe operation of the electrical energy storage device and thus the entire power supply system.

The functional parameter can for example be the temperature of an energy storage cell which is not to exceed a specific maximum temperature so as to prevent an igniting of or other damage to the electrical energy storage device. A measure for adhering to the target value can then for example be a decreasing of the charge current momentarily drawn from the energy storage cell and/or an intensified cooling of the energy storage cell and/or the automatic supply of a cooling or extinguishing agent. Should these measures not be able to reduce the cell temperature below the given maximum temperature, the overheated energy storage cell or cell module or even the entire electrical energy storage device is switched off. In the latter case, the control device preferably attempts to only switch off the fewest possible energy storage cells and/or cell modules so as to maintain the power supply system operation—if needed in limited form.

The user is preferably informed about such a measure and/or disconnection and, if the available capacity of the electrical energy storage device has been changed by the measure or the disconnection, receives notification of said change in capacity.

In a further preferred embodiment of the invention, the measurement and/or evaluation and/or storing of at least one functional parameter or a variable derived from said functional parameter of the at least one energy storage cell occurs when the high-voltage region is substantially de-energized. Such a de-energized state of the high-voltage region can for example be present when the power supply system as a whole has not yet been put into operation, for example after the assembly of the power supply system or parts thereof as a structural unit but still prior to it being installed into the motor vehicle, or also after being removed from the vehicle and prior to disassembly and/or scrapping of the power supply system.

Already in this state, which can persist over a longer period of time and in which for example the transport or the storage of the power supply system or parts thereof, particularly the electrical energy storage device, takes place, it is important to monitor and document the state of the electrical energy storage device.

Events in this state of the electrical energy storage device which are of interest and which should be detected include, for example, short circuits, the loosening of contacts (for example due to vibrations during transport), the development of dangerous heat or inadvertent discharging, for instance due to moisture-related creepage currents. Generally speaking, this monitoring serves in the safety as well as in preserving the value of the electrical energy storage device preferably during transport and storage. The possibility of such monitoring can even be stipulated by legal regulations.

However, the high-voltage region can also be in a de-energized state after the vehicle has been put into operation when it is not being used at that particular moment or if the high voltage within the high-voltage region is switched off for another reason, for example after impact detection.

In a further preferred embodiment of the invention, the control device determines whether an energy storage cell or a cell module is suitable for the power supply system and/or in which state an energy storage cell or a cell module is.

Such a suitability check on an energy storage cell or a cell module can preferably be performed when the electrical energy storage device is initially equipped with energy storage cells and/or cell modules, but also when replacing one or more energy storage cells or cell modules, for example for being defective or too old.

The suitability check can thereby relate for example to the type, the available voltage or the available current of the energy storage cell. The suitability check can thereby utilize the corresponding measured functional parameters of the energy storage cell or the cell module. It is however also possible for the suitability check to be run by reading data over a communication link between the control device and preferably a cell module. In this way, further parameters relevant to the suitability of the energy storage cell or the cell module can be determined such as, for example, the manufacturer, an identification number or such functional parameters that cannot be physically measured directly but which are stored in data form in the energy storage cell or in the cell module, for example the highest or lowest permissible operating temperature or the maximum discharge current.

The result of such a suitability check can be the acceptance of the energy storage cell or cell module analyzed and its electrical and/or data-related integration into the electrical energy storage device. However, the result can also be the rejection of the energy storage cell or cell module along with the output of the corresponding information to the user or service personnel.

An initial check of the state of the energy storage cell or cell module, e.g. determining the state of charge, can correspondingly take place. The result of such a check of the state can be an automatic recharging of the new energy storage cell or new cell module to a specific state of charge or the cooling or heating up to a specific operating temperature.

Both the check of suitability as well as the check of state of an energy storage cell or cell module newly integrated into the electrical energy storage device serve in correctly configuring and safely operating the electrical energy storage device.

In accordance with a further preferred embodiment of the invention, the measurement and/or the evaluation and/or the storing of at least one functional parameter or a variable derived from said functional parameter of the at least one energy storage cell occurs when the high-voltage region is subjected to high voltage.

This state of the power supply system generally occurs during the proper and unproblematic operation of the power supply system. In this state the control apparatus also fulfills its main task, i.e. controlling the electrical energy storage device during operation of the motor vehicle in a nearly optimum, i.e. energy-saving and/or conserving of the electrical energy storage device, manner. Optimizing the operation can for example take into account the aging of individual energy storage cells and their charge behavior within the cell module containing them or within the electrical energy storage device as a whole in order to increase the utility value of the electrical energy storage device and prolong its service life.

A further preferred embodiment of the invention is characterized in that upon an abnormal operating condition, particularly an accident,

the control device interrupts the electrical connection between at least two energy storage cells or cell modules and/or

the evaluation of the at least one functional parameter of the at least one energy storage cell comprises the step of assessing the functioning of the energy storage cell, a cell module or the electrical energy storage device and/or

a variable derived from the at least one functional parameter of the at least one energy storage cell is a report on the functioning of the energy storage cell, a cell module or the electrical energy storage device.

The cited features correspond to an “accident safety mode” in which, by separating the energy storage cells or cell modules, an uncontrolled, sudden discharging of the energy storage cells is to be prevented by selectively interrupting electrical connections within the electrical energy storage device.

At the same time—to the extent it can be automated—the energy storage cells are assessed for possible damages from the accident, preferably by initiating a test program on the energy storage cells.

Ultimately, the user of the motor vehicle should receive a report after the accident which provides reliable information about the further operability of the individual energy storage cells, the cell module or the entire electrical energy storage device. This report should enable the user to make the decision as to whether to continue operating the vehicle—for example in emergency mode—or whether external assistance is required. The operability report on the energy storage system is then also directly available to a summoned service technician and can support him in his diagnostic and repair work.

In a further preferred embodiment of the invention, the energy storage cells are rechargeable and the control device can equalize different states of charge of different energy storage cells by shifting charges between said energy storage cells.

The drawing or storing of electrical charge can thereby be evenly distributed to the individual energy storage cells, particularly given a large number of energy storage cells connected in series. This process can increase the total usable capacity of the cell module and the electrical energy storage device and extend the service life of the individual energy storage cells and thus the entire electrical energy storage device. Both so-called static as well as so-called dynamic methods are known for realizing such an equalization of charge.

In a further preferred embodiment of the invention, the control device can control energy storage cells or cell modules of different types and/or different capacities and/or different performance characteristics.

This thereby enables the energy storage system to have a more flexible configuration in that within one energy storage system, ionic and non-ionic energy storage cells, for example, can be mixed and operated together with lithium ion batteries, lithium polymer batteries, lithium iron phosphate batteries and lead batteries, high-power and high-energy batteries or even electrical and electrochemical energy storage cells such as capacitors and accumulators. Energy storage cells of different capacities can also be accordingly mixed and their capacities cumulated. The electrical energy storage device can preferably be progressively “upgraded” over time as new types of batteries with larger capacities become available.

In a further preferred embodiment of the invention, the control device can modify the voltage in the high-voltage region, in particular switching it on or off, depending on the state of the power supply system, particularly depending on operational and/or hazard conditions.

Such a hazard condition preferably is the recognizing of an impact of the motor vehicle, after which the high voltage should be immediately switched off in the vehicle since the impact can expose live parts which can pose a mortal danger to passengers or a third party.

An operational condition in which the high voltage within the high-voltage region should be switched on or off is preferably the operation or the non-operation respectively of the vehicle, but for example also the opening and/or closing of a battery cover or a hood, which thereby exposes components which either themselves carry a high voltage (for example the electric motor) or which act on such components (for example by being in contact with parts of the electrical energy storage device). This feature thus also serves the safe operation of the power supply device.

In a further preferred embodiment of the invention, the control device can collect data on the power flow between the high-voltage region and the low-voltage region, preferably in both directions. A prerequisite for detecting the power flow in both directions is that the voltage converter functions bidirectionally, thus can convert both a low voltage into a high voltage and a high voltage into a low voltage.

While, during the normal operation of the motor vehicle, power flows from the electrical energy storage device in the low-voltage region to the electrical load in the high-voltage region, a reverse power flow from the high-voltage region to the low-voltage region can occur when the electric motor of the motor vehicle is operated as a generator, preferably upon regenerative braking, and the energy thereby generated is fed back into the electrical energy storage device.

Another case of a power flow from the high-voltage region to the low-voltage region can occur when charging the electrical energy storage device, particularly in the case of an external charging preferably taking place via a conventional 230 V mains connection, or in the case of an internal charging preferably taking place via a so-called “range extender,” i.e. a smaller combustion engine with an electrical generator having the objective of increasing the vehicle's range. In these cases, the voltage converter which is provided anyway can be used to generate the necessary low voltage.

The electrical energy storage device can lastly also be used as an external energy buffer for a power supply system, wherein the power flow during charging takes place as above and the reverse flow of the buffered energy into the power supply system produces a power flow from the low-voltage to the high-voltage region.

In all the cited cases, the control device can measure, evaluate and store data on the electrical power and energy transmitted so that up-to-date information on the state of the electrical energy storage device, for example the state of charge, can always be derived therefrom, also, if necessary, for the purpose of billing accounts for extracted and/or supplied energy.

In a further embodiment of the invention, the control device can monitor each cell module separately, wherein the at least two cell modules within the electrical energy storage device are preferably connected to one another in parallel. This can also increase the service life of the cell module and the energy storage cells contained therein. Monitored parameters and/or identified events include for example cell module voltages, currents, temperatures or the states of charge of the cell modules as well as cell module overvoltages and undervoltages, overcurrents, overheating, short circuits or connection interrupts.

In a further embodiment of the invention, the control device can charge individual energy storage cells or cell modules at least partially individually. In so doing, the potentially different charge states or capacities of the individual energy storage cells, due for example to the different aging of the energy storage cells, can be taken into account. Similar to the above-described equalizing of charge between individual energy storage cells, this enables a more uniform charging and discharging of the individual energy storage cells, which in turn increases their service life as well as the performance of the electrical energy storage device as a whole.

It goes without saying that two or more of the above-described embodiments of the invention can also be combined with one another at will to the extent that doing so is technically possible.

The drawings which follow depict exemplary embodiments of the power supply system according to the invention in the form of block diagrams. Shown are:

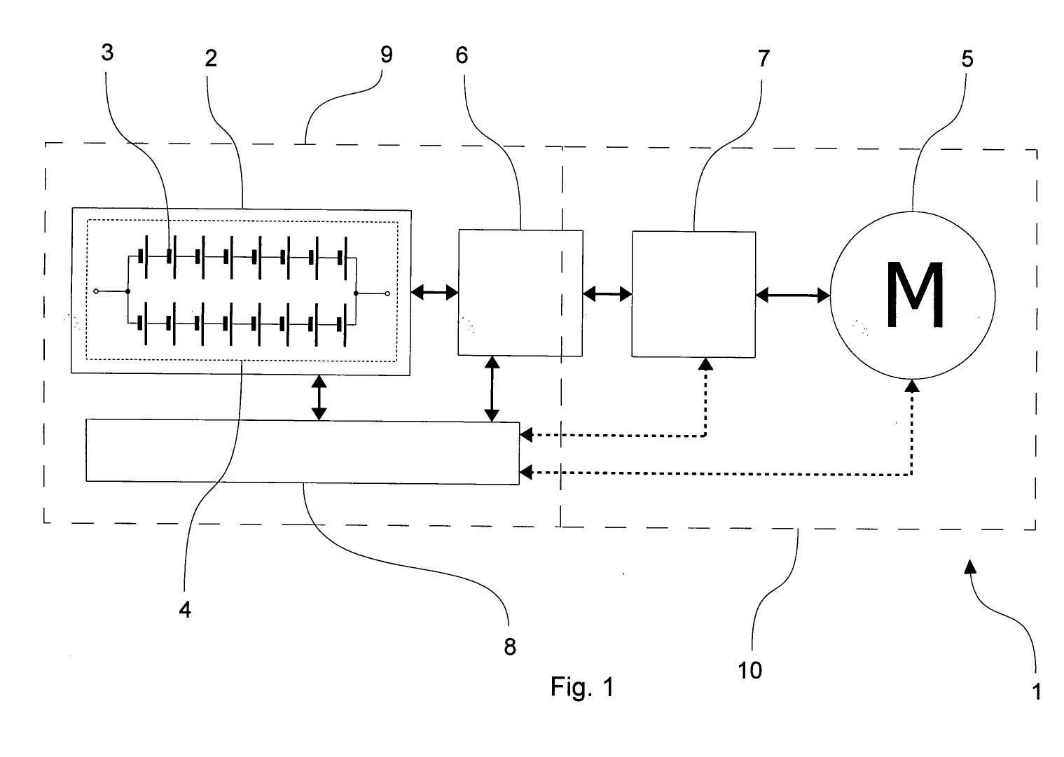

FIG. 1 a block diagram of a power supply system according to the invention, and

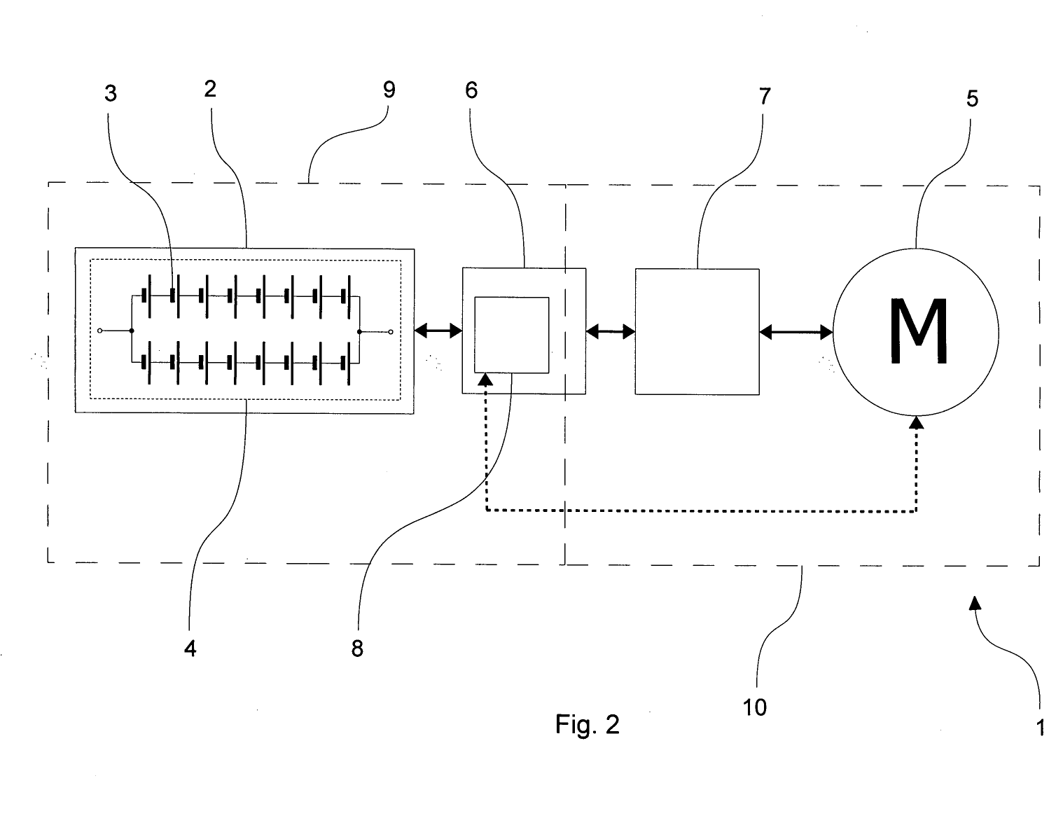

FIG. 2 a block diagram of a power supply system according to the invention in which the control device is integrated into the voltage converter.

FIG. 1 shows an embodiment of a power supply system 1 according to the invention for use in an electric or hybrid vehicle, wherein the two enclosing blocks delimited by broken lines represent the low-voltage region 9 and the high-voltage region 10 respectively.

A battery 2, a battery management system 8 as well as that part of the voltage converter 6 in which only low voltages prevail are provided within the low-voltage region 9. The battery 2 hereby represents the electrical energy storage device and the battery management system 8 the control device. The voltage converter 6 is a DC/DC converter. The battery 2 can comprise one or more cell modules 4, one of which is indicated by a finely dashed boundary line depiction. The cell module 4 in turn comprises two parallel-connected strands of eight battery cells 3 each connected in series.

In the embodiment, the individual battery cells 3 each have a nominal voltage of 4 V such that each cell strand, and thus also the entire cell module as a whole, has a nominal voltage of 32 V. The battery cells 3 are for example lithium ion cells having a maximum storage capacity of 60 Ah each.

The battery management system 8 to control the battery 2 is likewise provided in the low-voltage region 9. The battery management system 8 performs all or a portion of the above-described functions, also including regulating the charging process for the battery 2.

In one exemplary configuration, the battery 2 can be charged normally at a charging rate of 1 to 3 C/s, at a maximum of 5 C/s, and briefly (maximum 3 s) at 90 C/s. Discharging of the battery 2, which is likewise regulated by the battery management system 8, normally occurs at 1 to 10 C/s, at a maximum of 20 C/s, and briefly (3-4 seconds) at 125 C/s. The latter peak discharge rate serves in providing a momentarily needed high propulsion power, particularly when overtaking other vehicles, whereby the peak discharge rate can be reached extremely quickly, for example with an initiation time of 40 ms. The minimum operating temperature of the battery 2 amounts to −40° C. Further exemplary data of the battery management system 8 include an energy requirement of 6 mW, the possibility of external monitoring and diagnosis via an I²C or a CAN bus, an RS-232 or USB connection. The battery management system 8 meets the IEC 62660 testing standard as well as further ISO standards and standards for electromagnetic compatibility.

The battery management system 8 can be realized as a circuit on a circuit board, for example dimensioned at 250×80 mm, 180×200 mm or 200×300 mm with a maximum height of 28 mm, or can be implemented as an individual integrated circuit.

The functional connections between the components of the power supply system 1 are suggested by the double arrows in FIG. 1, which can stand for communication and/or power supply lines. In the communication line case, the connection can for example be established, as noted above, via a CAN bus or via a serial RS-232 interface.

In the low-voltage region 9, the battery 2 is connected to the low-voltage input of the voltage converter 6. The battery management system 8 is connected to the battery 2 as well as to the part of the voltage converter 6 within the low-voltage region in order to, for example, detect a malfunctioning or failure of the voltage converter 6 and thereupon be able to switch off the battery 2 in an emergency.

The part of the voltage converter 6 in which also high voltages prevail is disposed in the high-voltage region 10. Since the battery 2 supplies DC voltage and the voltage converter 6 is also a DC/DC converter, the high-voltage output of the voltage converter 6 is connected to an inverter 7 which converts the high direct voltage supplied by the voltage converter 6 into high alternating voltage. Power semiconductors aid in the converting which occurs in inverter 7.

The battery management system 8 is also connected to the inverter 7; however, this connection is not permanent since the high-voltage region 10 can for example be disconnected from the low-voltage region 9 in an emergency, whereby the cited connection is broken as well. This connection is thus indicated by means of a broken arrow.

An electric motor 5 is further disposed in the high-voltage region 10 as an electrical load. The electric motor 5 can drive the mechanical drive system of the motor vehicle (not shown), consisting for example of a driveshaft, a clutch, a transmission, a differential gear and one or more driven wheels. It is however also possible for the electric motor 5 to be designed as a wheel hub motor and directly drive a drive wheel. In this case, a plurality of electric motors 5 can be provided, i.e. for each driven wheel, wherein the electric motors 5 are individually controllable to produce the torque required for the respective wheel. The electric motor 5 can furthermore also be a part of a hybrid drive having an additional combustion engine (not shown).

The electric motor 5 is also connected to the battery management system 8, for example to detect an abnormal operating state such as overheating and a subsequent emergency shut-down of the battery 2. This connection is depicted as a broken arrow for the same reasons as above. The connections between the battery management system 8 on the one side and the inverter 7 and/or the electric motor 5 on the other are only communication lines, not however power supply lines, since a transmission of energy between the battery management system 8 in the low-voltage region 9 and the inverter 7 or electric motor 5 in the high-voltage region 10 would not be readily possible without a further voltage converter.

The power supply system 1 according to the invention can also contain further components not depicted in FIG. 1, for example a motor control unit to provide a required torque, a charging device for the battery 2 providing an external charger connector, or various sensors for measuring the battery or other parameters such as the battery voltage, the battery current, the battery temperature or the acceleration to which the battery 2 is subjected.

The electric motor 5 can also be used as a generator, particularly to recover braking energy. The power flow then runs from right to left in FIG. 1, i.e. the high voltage produced by the electric motor 5 is converted in inverter 7, which in this case functions as a rectifier, or in an additionally provided rectifier, into a high direct voltage which is converted by the voltage converter 6 into a low direct voltage with which the battery 2 is ultimately charged.

All the cited functions can thereby be controlled and/or monitored by the battery management system 8.

FIG. 2 shows a further configuration of a power supply system 1 according to the invention, in which the battery management system 8 is integrated into the voltage converter 6. The integration can thereby be realized as an additional circuit board or an additionally integrated circuit within the voltage converter 6 or also an integrated circuit containing both the battery management system 8 as well as the voltage converter 6. The embodiment of the invention depicted in FIG. 2 is characterized by its minimum expenditure for hardware additionally provided for the control device 8.

Ideally, the functions of the battery management system 8 are wholly implemented in a microprocessor already provided in the voltage converter 6 anyway. In this case, realizing the battery management system 8 only requires the necessary sensors for the battery and other parameters.

Integrating the battery management system 8 into the voltage converter 6 also allows dispensing with the connection lines from the battery management system 8 to the voltage converter 6, the battery 2 and the inverter 7, since the internal lines in the voltage converter 6 and/or the connection lines already existing between the voltage converter 6 and the battery 2 and/or the inverter 7 can be used for the same purpose. Doing so also results in a lower wiring expenditure within the power supply system 1. Only one connection line to the electric motor 5, which is not directly adjacent to the voltage converter 6, is still provided.

### LIST OF REFERENCE NUMERALS

1 power supply system
2 battery
3 battery cell
4 cell module
5 electric motor
6 voltage converter
7 inverter
8 battery management system
9 low-voltage region
10 high-voltage region

1.-14. (canceled)

15. A power supply system for at least one of an electric and hybrid drive of a motor vehicle, the power supply system comprising:
an electrical energy storage device supplying a low voltage and comprising at least one energy storage cell;
an electrical load operated at a high voltage;
a voltage converter electrically connected to the electrical energy storage device and the electrical load, the voltage converter converting at least one of a low voltage into a high voltage and a high voltage into a low voltage, the voltage converter converting the low voltage supplied by the electrical energy storage device into the high voltage for operating the electrical load;
a low-voltage region in which the electrical energy storage device is arranged;
a high-voltage region in which the electrical load is arranged;
a control device, for controlling the electrical energy storage device, arranged substantially in the low-voltage region.

16. The power supply system as set forth in claim 15, wherein:
the electrical energy storage device comprises at least one cell module having at least two of the energy storage cells.

17. The power supply system as set forth in claim 15, wherein:
the voltage converter is a DC/DC converter.

18. The power supply system as set forth in claim 15, wherein:
the control device is integrated into the voltage converter.

19. The power supply system as set forth in claim 15, wherein the control device includes:
a measuring device for measuring at least one functional parameter of the at least one energy storage cell;
an evaluating device for evaluating the at least one functional parameter of the at least one energy storage cell; and
at least one storage unit for storing at least one of the at least one functional parameter and a variable derived from the at least one functional parameter.

20. The power supply system as set forth in claim 19, wherein the electrical energy storage device includes:
at least one cell module having at least two of the energy storage cells;
wherein the at least one variable derived from the at least one functional parameter is at least one of an age and a residual lifespan of the electrical energy storage device, the cell module, and the at least one energy storage cell.

21. The power supply system as set forth in claim 20, wherein:
when the at least one of the functional parameters of an energy storage cell deviates from a target value, the control device initiates at least one measure to ensure adherence to the target value; and;
if the at least one of the functional parameters continues to deviate from the target value after the initiated measure, the control device switches off the energy storage cell.

22. The power supply system as set forth in claim 21, wherein:
the measuring, evaluating, and storing of the at least one of the at least one functional parameter and the at least one variable derived from the functional parameter of the at least one energy storage cell occurs when the high-voltage region is substantially de-energized.

23. The power supply system as set forth in claim 22, wherein:
the control device determines whether the energy storage cell or the cell module is suitable for the power supply system and the respective states of the energy storage cell and the cell module.

24. The power supply system as set forth in claim 21, wherein:
the measuring, evaluating, and storing of the at least one of the at least one functional parameter and the at least one variable derived from the functional parameter of the at least one energy storage cell occurs when the high-voltage region is subjected to the high voltage.

25. The power supply system as set forth in claim 24, wherein upon an abnormal operating condition:
the control device interrupts the electrical connection between at least two of the energy storage cells or cell modules;
the evaluation of the at least one functional parameter of the at least one energy storage cell includes assessing the functioning of at least one of the energy storage cell, the cell module, and the electrical energy storage device; and
the variable derived from the at least one functional parameter of the at least one energy storage cell reports the functioning of at least one of the energy storage cell, the cell module, and the electrical energy storage device.

26. The power supply system as set forth in claim 20, wherein:
the control device controls the at least one energy storage cell or the at least one cell module of different types, different capacities, different performance characteristics.

27. The power supply system as set forth in claim 15, wherein:
the at least one energy storage cell is rechargeable and the control device can equalize different states of charge of different ones of the energy storage cells by shifting charges between the energy storage cells.

28. The power supply system as set forth in claim 15, wherein:
the control device modifies the voltage in the high-voltage region based on at least one of operational and hazard conditions.

29. The power supply system as set forth in claim 28, wherein:
the control device modifies the voltage in the high-voltage region by switching the high-voltage region on or off.

30. The power supply system as set forth in claim 15, wherein:
the control device collects data on power flow between the high-voltage region and the low-voltage region.

31. A method of controlling a power supply system, the method comprising:
supplying a low voltage from an electrical energy storage device, which is arranged in a low-voltage region and comprises at least one energy storage cell;
receiving the low voltage at a voltage converter electrically connected to the electrical energy storage device and an electrical load;
converting the low voltage supplied by the electrical energy storage device into a high voltage for operating an electrical load, which is arranged in a high-voltage region; and
controlling the electrical energy storage device in the low-voltage region.

32. The method of controlling a power supply system as set forth in claim 31, further including:
measuring at least one functional parameter of the at least one energy storage cell;
evaluating the at least one functional parameter of the at least one energy storage cell; and
storing at least one of the at least one functional parameter and a variable derived from the at least one functional parameter.

33. The method of controlling a power supply system as set forth in claim 32, further including:
when the at least one of the functional parameters of an energy storage cell deviates from a target value, initiating at least one measure to ensure adherence to the target value; and;
if the at least one of the functional parameters continues to deviate from the target value after the initiated measure, switching off the energy storage cell.

34. The method of controlling a power supply system as set forth in claim 32, further including:
interrupting the electrical connection between at least two of the energy storage cells or cell modules; and
reporting functioning of at least one of the energy storage cell, the cell module, and the electrical energy storage device based on the variable derived from the at least one functional parameter of the at least one energy storage cell;
wherein the evaluating includes:
assessing the functioning of at least one of the energy storage cell, the cell module, and the electrical energy storage device.
